(19) United States
(12) Patent Application Publication
(10) Pub. No.: US 2019/0308340 A1
(43) Pub. Date: Oct. 10, 2019

(54) SYSTEM FOR SECURING A POTTERY BAT TO A POTTERY WHEEL HEAD

(71) Applicant: Joaquin Valle, Santa Barbara, CA (US)

(72) Inventor: Joaquin Valle, Santa Barbara, CA (US)

(21) Appl. No.: 16/379,071

(22) Filed: Apr. 9, 2019

Related U.S. Application Data
(60) Provisional application No. 62/655,442, filed on Apr. 10, 2018.

(51) Int. Cl. B28B 1/02

(52) U.S. Cl. CPC B28B 1/025

(57) ABSTRACT

A system for securing a pottery bat to a pottery wheel is provided. The system ensures that the pottery bat is securely held to the pottery wheel and that the attachment can be appropriately tightened, eliminating any movement between the bat and pottery wheel, even when rotating at speed. In one embodiment, a pottery bat having special retention features for positively engaging the bat to the bat pins is provided. These features include one or more set-screw that impinges and tightens upon a bat pin while being secured to the bat by threads. In another embodiment, a specialized fastener is threaded to a specialized nut or receiver with the bat and pottery wheel sandwiched in between.

### CROSS-REFERENCE TO RELATED APPLICATIONS

This application claims the benefit of U.S. Provisional Application No. 62/655,442, filed on Apr. 10, 2018, the subject matter of which is incorporated herein by reference.

### TECHNICAL FIELD

The present disclosure relates generally to the field of pottery making, and more particularly to a system for securing a pottery bat to a pottery wheel head.

### BACKGROUND

A pottery bat is a device attached to a pottery wheel providing a surface for a workpiece to rest on during a shaping process. A pottery bat allows the workpiece to be easily removed from the pottery wheel, as well as provide an interchangeable and cleanable surface for supporting the workpiece. Typically, pottery bats are constructed of wood, plastic, or plaster, in contrast to the ceramic workpiece.

The pottery bat is usually attached to the pottery wheel by bat pins, which pass through the pottery wheel head and form index points for the bat to spin upon in conjunction with the pottery wheel. Because traditional pottery bats rely on such bat pins, it is easy to inadvertently remove the bat from the pottery wheel at an inopportune time, especially when manipulating a workpiece supported by the bat. Even if a bat is snugly fitted, it may work loose over time. At best, this occurrence is a frustrating inconvenience; at worst, it may ruin the workpiece, or cause injury. In addition, unless the bat pins are carefully fitting to an individual bat, movement between the pottery bat and the bat pin can hinder precision work.

### SUMMARY

A system for securing a pottery bat to a pottery wheel is provided. The system ensures that the pottery bat is securely held to the pottery wheel and that the attachment can be appropriately tightened, eliminating any movement between the bat and pottery wheel, even when rotating at speed. In one embodiment, a pottery bat having special retention features for positively engaging the bat to the bat pins is provided. These features include one or more set-screw that impinges and tightens upon a bat pin while being secured to the bat by threads. In another embodiment, a specialized fastener is threaded to a specialized nut or receiver with the bat and pottery wheel sandwiched in between.

### BRIEF DESCRIPTION OF THE DRAWINGS

FIG. 1 shows an example system for attaching a pottery bat to a pottery wheel head in use, according to an embodiment of the disclosure.

FIG. 2 shows an exploded view of the system for attaching a pottery bat to a pottery wheel head of FIG. 1.

FIG. 3 shows a top view of an example pottery bat.

FIG. 4 shows a side view of the example pottery bat.

FIG. 5 an example system for attaching a pottery bat to a pottery wheel head in use, according to a another embodiment of the disclosure.

FIG. 6 shows an exploded view of the system for attaching a pottery bat to a pottery wheel head of FIG. 5.

FIGS. 7A-7C show detailed views of the example fastener illustrated in FIGS. 5 and 6.

### DETAILED DESCRIPTION OF EXAMPLE EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

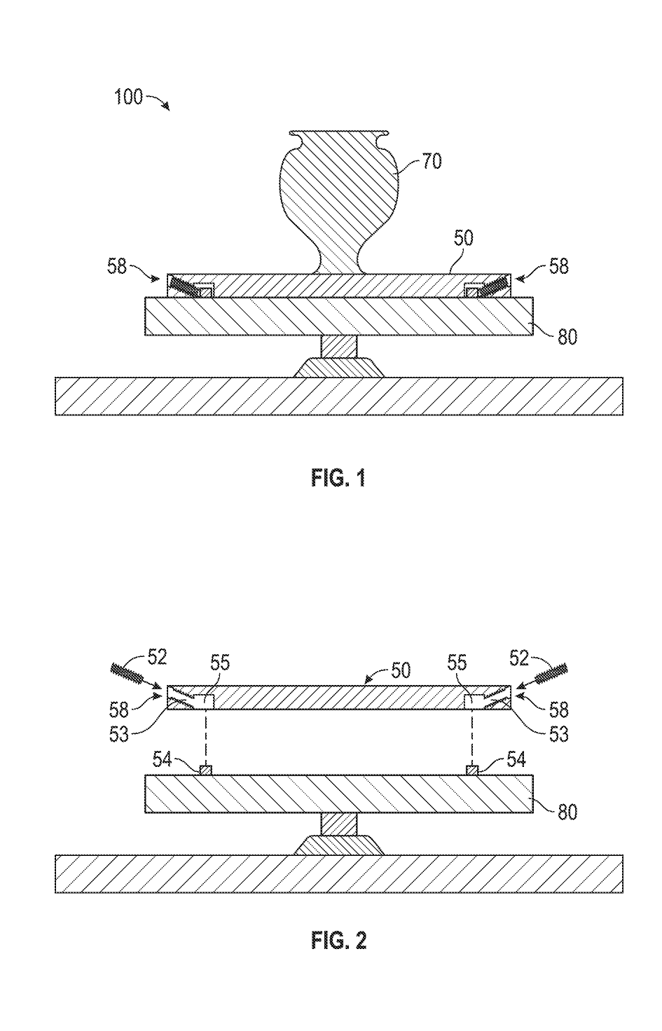

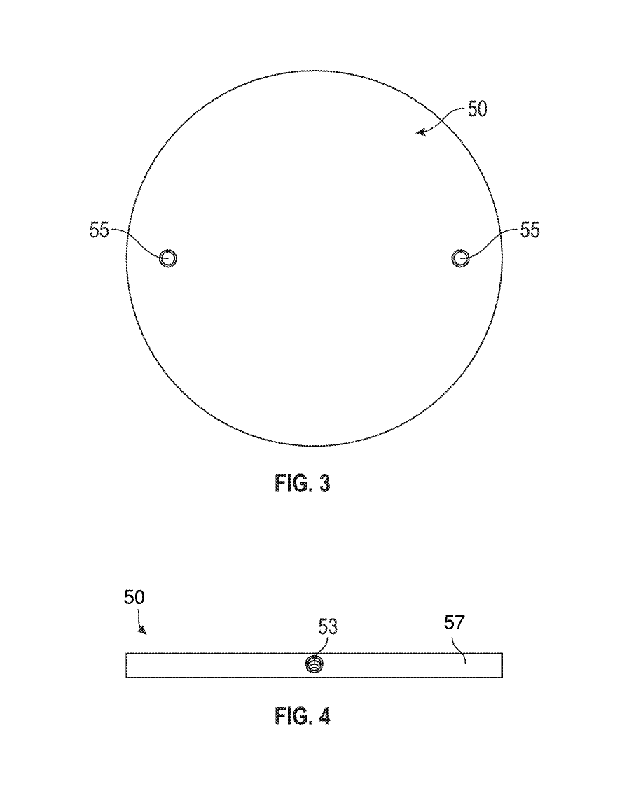

Referring now to the drawings, there is shown in FIG. 1 a system 100 for securing a pottery bat 50 to a pottery wheel 80 during an in-use condition (working on vase 70) and in FIG. 2 an exploded view of the system 100, according an example embodiment of the disclosure. The system 100 comprises a retainer mechanism 58 built into the bat 50 for use with traditional bat pins 54. In this embodiment, a specialized bat is used in conjunction with the system 100. As can be most clearly seen in FIG. 3, the bat 50 can be disk shaped and include traditional bat pin cavities 55 used to index the bat 50 to the bat pins 54. The bat 50 also includes side holes 53 which intersect and are not parallel to the bat pins 54. Each of the side holes 53 may be internally threaded to accept a screw such as the set-screw 52 (which can be headless, as shown). In operation, each of the set-screws 52 may be installed and threaded into a respective side hole 53 by turning (e.g., in a clockwise direction) until it impinges upon and tightens against the corresponding bat pin 54, thereby positively locking the bat 50 to the bat pin 54. The set-screws 54 may be untightened (and removed, if desired) by turning in the opposite direction (e.g., in a counterclockwise direction). One side hole 53 and one set-screw 52 may be provided for each bat pin 54, as shown. However, in other embodiments only a single set-screw 52 may be used to secure one of the bat pins 54 even where there is a pair of bat pins 54. In this case, one of the bat pins 54 would not be secured using a set-screw 52. Still further embodiments may include a fewer or greater number of bat pins. In general, the number of set-screws 52 used can be any number up to the total number of bat pins provided. Preferably, the side holes 53 are substantially cylindrical, and each may originate in one opening located on the rim 57 of the bat 50 (as shown in FIG. 4), and extend to an entrance to one of the bat pin cavities 55. However, it is to be understood that the set-screws 52 can extend through the entrances to the bat pin cavities 55 so as to press against the bat pins 54. Preferably, the bat pin 55 cavities are cylindrical as well, and may be substantially parallel to the axial center of the bat 50, as is typical. The side holes 53 are each preferably disposed at between about a forty and a sixty-degree angle to the respective bat pin cavity 55 such that the set-screw 52 is inserted at a non-straight angle into the bat pin cavity 55. This angle enables a user to more easily access and manipulate the set-screw 52 when removing or installing the bat 50, as the top of the set-screw is angled up and away from the pottery wheel 80.

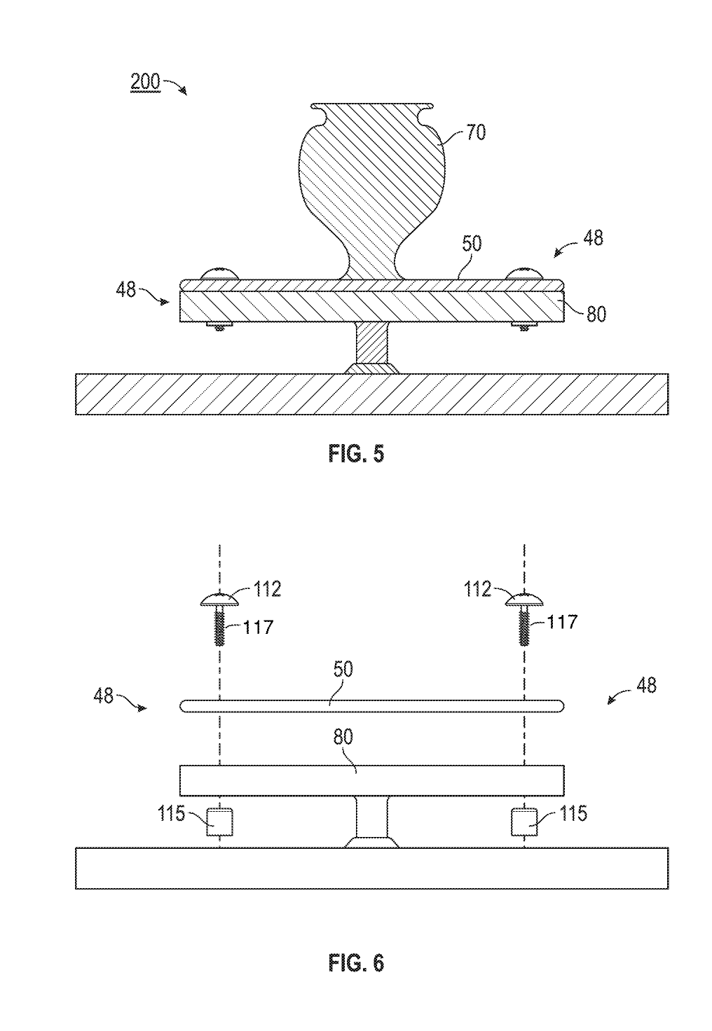

Referring again to the drawings, there is shown in FIG. 5 a system 200 for securing a pottery bat 50 to a pottery wheel 80 during an in-use condition (working on the vase 70 again) and an exploded view thereof in FIG. 6, according to another example embodiment of the disclosure. In the system 200, a bat fastener 48 is used to secure the pottery bat 50 to the pottery wheel 80. In some embodiments, the fastener 48 may supplement bat pins while in other embodiments, the fastener 48 may replace bat pins. As shown, the fastener 48 includes a first fastener portion 112 that threadably connects to a second fastener portion 115. The shank 117 of the first fastener portion 112 can pass through a hole extending through the bat 50 and the pottery wheel 80, with the head of the first fastener portion 112 resting on the top surface (work surface) of the bat 50. The second fastener portion 115 can fasten to the shank 117 of the first portion and may be inserted into the hole such that majority of the second fastener portion 115 is disposed in the hole. The second fastener portion 115 can be fastened on the underside of the pottery wheel 80, thereby “sandwiching” the bat 50 and pottery wheel 80 between the first fastener portion 112 and the second fastener portion 115 of the fastener 48 effectively and positively fastening the bat 50 to the pottery wheel 80. The first fastener potion 112 and the second fastener portion 115 can be sufficiently tightened to prevent significant axial, radial, and/or rotational movement of the bat 50 relative to the pottery wheel 80.

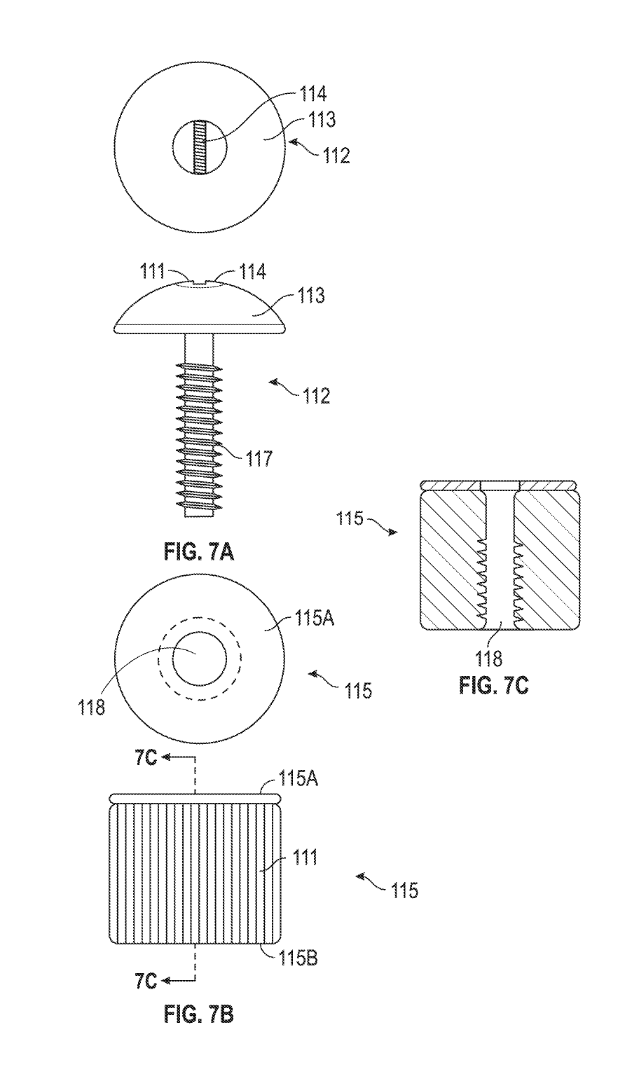

Referring now to FIG. 7A, close-up views of the first fastener portion 112 are illustrated. As depicted, the first fastener portion 112 includes a domed head 113 having a shallow curvature and a slot 114 to accommodate a flat-head screwdriver or the like. The shallow curvature of the head 113 is designed to minimize the protrusion of the fastener 48 above the bat 50. In this way, the fastener 48 interferes minimally with a workpiece placed on top of the bat 50, or the hands of a user during shaping. Although the head 113 is shown with the slot 114, it is to be understood that the slot 114 is an optional feature and the head 113 may instead have a slot of another shape.

Referring now to FIG. 7B, close-up views of the second fastener portion 115 are illustrated. The second fastener portion 115 can include a substantially flat top 115A and bottom 115B. The second fastener portion 115 can have an axial length of two-and-five eighths of an inch. Alternate embodiments may include other lengths. Preferably, the second fastener portion 115 is constructed of plastic, although in some embodiments, components of metal or other materials may be incorporated for strength and durability. The second fastener portion 115 may have a circular exterior sidewall 111, and may include external ribbing about the outside of the exterior sidewall so that a user may grip the receiver during installation or removal. The ribs on the sidewall 111 may be parallel to the axis of the aperture of the second fastener portion 115. In a preferred embodiment, the second fastener portion 115 includes an internal aperture 118 that can be only partially threaded. Further, the unthreaded portion of the internal aperture 118 of the receiver may include a taper which widens toward the mouth of the second fastener portion 115, enabling more expedient insertion of the first fastener portion 112 into the second fastener portion 115. This unthreaded portion may have an axial length of one-quarter of an inch, or other lengths, in embodiments. In another embodiment, the second fastener portion 115 may be threaded throughout the entirety of the internal aperture 118.

Additional features of the system 200 may include a friction enhancing coating to the fastener 48. Preferably, the coating can be a rubber or like compound, and may be applied only to the domed head 113 of the fastener. In other embodiments, additional portions of the fastener 48 may be coated. Yet another component of the system 200 can be a pliable washer disposed on the underside of the domed head 113 opposite to the face of the head 113, and proximal to the threaded shank 117. In this position, when assembled, the pliable washer may be sandwiched between the fastener head 13 and the top surface of the bat 50. The pliable washer may add cushioning and retention as the fastener is tightened.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A pottery bat securing system, comprising:
a bat having at least one pin hole;
at least one side hole formed in a rim of the bat, the at least one side hole extending to an entrance to the at least one pin hole; and
at least one screw extending into one of the at least one pin hole.

2. The pottery bat securing system of claim 1, wherein the at least one side hole is threaded.

3. The pottery bat securing system of claim 1, wherein the bat is disc shaped.

4. The pottery bat securing system of claim 1, wherein the at least one screw is user-adjustable to impinge against a bat pin.

5. The pottery bat securing system of claim 1, wherein the at least one screw is a set-screw.

6. The pottery bat securing system of claim 1, wherein the at least one screw is headless.

7. The pottery bat securing system of claim 1, wherein the at least one side hole is threaded to fit the at least one screw.

8. The pottery bat securing system of claim 1, wherein the at least one screw is user-adjustable to press against a bat pin.

9. The pottery bat securing system of claim 1, wherein the at least one screw is user-adjustable by turning the screw.

10. A pottery bat securing system, comprising:
a bat with a disc shape, the bat having at least one pin hole disposed in a bottom surface thereof;
at least one threaded side hole disposed in a lateral side of the bat, each of the at least one threaded side hole extending to an entrance of the at least one pin hole; and
at least one set-screw capable of extending past the entrance and into one the at least one pin hole to impinge against a bat pin therein.

11. The pottery bat securing system of claim 10, wherein the at least one set-screw is headless.

12. The pottery bat securing system of claim 10, wherein the at least one threaded side hole is threaded to fit the at least one set-screw.

13. The pottery bat securing system of claim 10, wherein the at least one threaded screw is user-adjustable to press against a bat pins within the at least one pin hole.

14. The pottery bat securing system of claim 10, wherein the at least one set-screw is user-adjustable to press against bat pin by turning the at least one set-screw.

15. The pottery bat securing system of claim 14, wherein the at least one set-screw increases pressure against the bat pin by turning the at least one set-screw in a clockwise direction.

16. The pottery bat securing system of claim 14, wherein the at least one set-screw decreases pressure against the bat pin by turning the at least one set-screw in a counterclockwise direction.

17. A pottery bat securing system, comprising:
a bat having a pair of holes formed through the bat; and
a pair of fasteners, each fastener including a first part and a second part coupled together;
wherein the bat is capable of being attached to a pottery wheel by sandwiched in between bat and the pottery wheel between the first part and second part of the fastener.

18. The pottery bat of claim 17, wherein the first part of the fastener is a bolt having a head with a slot on a top surface thereof capable of receiving a flat head screwdriver.

19. The pottery bat of claim 18, wherein the second part of the fastener is capable of threadably receiving the first part of the fastener.

20. The pottery bat of claim 19, wherein a majority of each of the second fasteners is disposed within a respective one of the holes.
